(19) United States
(12) Patent Application Publication
(10) Pub. No.: US 2026/0290862 A1
(43) Pub. Date: Sep. 24, 2026

(54) FUEL CELL CONTROL SYSTEM

(71) Applicant: HONDA MOTOR CO., LTD., Tokyo (JP)

(72) Inventors: Takuma YAMAWAKI, Saitama (JP); Shuto MANIWA, Saitama (JP)

(21) Appl. No.: 19/565,691

(22) Filed: Mar. 13, 2026

(30) Foreign Application Priority Data
Mar. 21, 2025 (JP) 2025-047335

(51) Int. Cl. H01M 8/04223; B60L 58/12; B60L 58/40; H01M 8/0444; H01M 8/04537; H01M 8/04664; H01M 8/04746; H01M 16/00

(52) U.S. Cl. CPC H01M 8/04231; B60L 58/12; B60L 58/40; H01M 8/04455; H01M 8/04544; H01M 8/04664; H01M 8/04753; H01M 16/006; B60L 2240/547; H01M 2220/20; H01M 2250/20; H01M 2250/402

(57) ABSTRACT

A fuel cell control system includes a plurality of fuel cell systems; a cathode shutoff valve that changes a supply amount of oxidant gas to a cathode; a voltage detection unit that detects an output voltage of each fuel cell; and an oxygen consumption control unit that, when stopping operation, consumes residual oxygen in a state where the cathode shutoff valve is closed. The oxygen consumption control unit executes, in a case where the output voltage of one fuel cell system is higher than a first threshold voltage, first drop processing of decreasing the output voltage at a first voltage drop rate, and executes, in a case where the output voltage has become equal to or lower than the first threshold voltage, second drop processing of decreasing the output voltage at a second voltage drop rate having a larger change rate than the first voltage drop rate.

### BACKGROUND

### Technical Field

The present invention relates to a fuel cell control system that executes control for consuming oxygen remaining in a fuel cell when an operation is stopped, in a plurality of fuel cell systems in which fuel cell systems are provided in parallel.

### Related Art

In recent years, research and development related to fuel cells that contribute to the improvement of energy efficiency have been conducted so that more people can secure access to affordable, reliable, sustainable, and advanced energy.

In a fuel cell vehicle using a fuel cell as one of its power sources, there is a case where a plurality of fuel cell systems provided in parallel are mounted, and a high output is obtained by operating the plurality of fuel cell systems simultaneously according to required electric power. In such a vehicle, by appropriately controlling the timing of starting and stopping the operation of each of the plurality of fuel cell systems, improvement of power generation efficiency and suppression of degradation of the fuel cell can be achieved.

In the fuel cell system, when the operation of the fuel cell is stopped, there is a problem that degradation of electrodes and an electrolyte membrane occurs due to oxidant gas (oxygen) remaining in a cathode system. As a countermeasure to such a problem, a technique has been proposed in which, when the operation of the fuel cell is stopped, an appropriate amount of fuel gas such as hydrogen is supplied to an anode, and the fuel gas is caused to react with oxygen remaining in a cathode, thereby consuming the residual oxygen to suppress degradation of the fuel cell.

For example, Japanese Patent Publication No. 7163794 discloses a fuel cell system that performs oxygen consumption control for consuming oxygen remaining in the fuel cell when the fuel cell is shifted from a power generation state to a stopped state, the fuel cell system includes a load control unit that controls a current value of an output current that is output from the fuel cell, and the load control unit controls the output current of the fuel cell such that, in the oxygen consumption control, the higher the output voltage of the fuel cell, the smaller the output current.

### Citation List

### Patent Literature

Patent Literature 1: Japanese Patent Publication No. 7163794

### SUMMARY

Electric power generated during execution of oxygen consumption control for consuming oxygen remaining in the fuel cell is, for example, charged into a battery. However, in a case where a plurality of fuel cell systems are provided in parallel, oxygen consumption control is performed in each of the plurality of fuel cell systems, and the generated electric power may exceed allowable electric power of the battery.

In order to prevent the generated electric power during the oxygen consumption control from exceeding the allowable electric power of the battery, it is necessary, in the fuel cell during the oxygen consumption control, to maintain a relatively high voltage during the oxygen consumption control to avoid excessive output electric power caused by an increase in output current. However, maintaining a high output voltage in the fuel cell for a long period of time accelerates degradation of the fuel cell and, at the same time, causes prolongation of the time required for the oxygen consumption control and, consequently, prolongation of the time required for stopping the operation of the fuel cell system.

The present invention has been made to solve such a problem, and an object thereof is to provide a fuel cell control system capable of shortening the time required for the oxygen consumption control while suppressing the generated electric power during execution of the oxygen consumption control from becoming excessive in a plurality of fuel cell systems. Consequently, the present invention contributes to improvement of energy efficiency.

In order to achieve the object, a fuel cell control system according to a first aspect of the present invention includes a plurality of fuel cell systems in which a plurality of fuel cell systems are provided in parallel, each of the plurality of fuel cell systems including a fuel cell that performs power generation through an electrochemical reaction between fuel gas supplied to an anode and oxidant gas supplied to a cathode; a cathode shutoff valve that is provided on an upstream side and a downstream side of the cathode of the fuel cell in each of the fuel cell systems, and changes a supply amount of the oxidant gas to the cathode in accordance with an opening degree of the cathode shutoff valve; a voltage detection unit that detects an output voltage of the fuel cell in each of the fuel cell systems; and an oxygen consumption control unit that executes oxygen consumption control in which, when stopping operation of the plurality of fuel cell systems, power generation of the fuel cell in each of the fuel cell systems is continued in a state where the cathode shutoff valve is closed, to consume oxygen remaining in the fuel cell. The oxygen consumption control unit executes, when stopping operation of the plurality of fuel cell systems, in a case where the detected output voltage of the fuel cell in one selected fuel cell system is higher than a first threshold voltage that is higher than an output voltage during normal power generation, first drop processing of decreasing the output voltage of the fuel cell in the one selected fuel cell system at a first voltage drop rate. In addition, in a case where the detected output voltage of the fuel cell has become equal to or lower than the first threshold voltage, the oxygen consumption control unit executes second drop processing of decreasing the output voltage of the fuel cell in the one selected fuel cell system at a second voltage drop rate having a larger change amount per unit time than the first voltage drop rate. In a case where the first drop processing in the one selected fuel cell system is completed, the oxygen consumption control unit starts execution of the first drop processing in a next one of the fuel cell systems.

In this fuel cell control system, oxygen consumption control in which, in a plurality of fuel cell systems arranged in parallel, oxygen remaining in the fuel cell is consumed by allowing the fuel cell to perform power generation in a state where the cathode shutoff valve is closed is executed. At this time, the output voltage of the fuel cell is decreased at the voltage drop rate corresponding to the output voltage while monitoring the output voltage of the fuel cell.

That is, in a case where the output voltage of the fuel cell is higher than the first threshold voltage that is set to a value higher than the output voltage during normal power generation, the first drop processing of decreasing the output voltage at a predetermined first voltage drop rate is executed. In addition, in a case where the output voltage of the fuel cell has become equal to or lower than the first threshold voltage, the second drop processing of decreasing the output voltage at the second voltage drop rate in which the change rate (drop rate) is set to be greater than that of the first voltage drop rate is executed.

In the present invention, the output voltage of the fuel cell during the oxygen consumption control is regarded as having a strong positive correlation with the oxygen concentration in the fuel cell. That is, it is determined that the higher the output voltage of the fuel cell during the oxygen consumption control, the higher the oxygen concentration in the fuel cell. When the oxygen concentration in the fuel cell is high, the power generation capability of the fuel cell is high, so the instantaneous generated electric power tends to increase when the output voltage is decreased, and thus the possibility of exceeding the allowable electric power of the battery that stores the generated electric power of the fuel cell also increases. Therefore, in the present invention, during the high-voltage period in an early stage of the oxygen consumption control (a voltage higher than the first threshold voltage), the first drop processing of decreasing the output voltage at a predetermined first voltage drop rate is executed. The first voltage drop rate is set as a voltage drop rate having a relatively small change rate such that the generated electric power of the fuel cell does not exceed the allowable electric power of the battery.

By executing the first drop processing of decreasing the output voltage at the first voltage drop rate, the oxygen remaining in the fuel cell is gradually consumed, resulting in a gradual decrease in the power generation capability of the fuel cell. At this stage, in a case where the output voltage of the fuel cell has become equal to or lower than the first threshold voltage, the second drop processing of decreasing the output voltage at the second voltage drop rate having a greater change rate than that of the first voltage drop rate is executed. As described above, in the present invention, the output voltage is decreased using different voltage drop rates depending on the output voltage of the fuel cell. As a result, in each fuel cell system, as compared to a case where a fixed voltage drop rate is used, it is possible to decrease the output voltage of the fuel cell more quickly while preventing the generated electric power during the execution of the oxygen consumption control from exceeding the allowable electric power of the battery, and it is possible to shorten the time required for the oxygen consumption control.

In addition, in the present invention, in a case where the first drop processing in the one selected fuel cell system is completed, the oxygen consumption control unit starts execution of the first drop processing in a next one of the fuel cell systems. That is, instead of starting the oxygen consumption control in the next fuel cell system after completion of the oxygen consumption control in one fuel cell system, the execution of the first drop processing in the next fuel cell system is started at a stage where the first drop processing in one fuel cell system is completed and the processing transitions to the second drop processing. At a stage where the first drop processing in the next fuel cell system is completed, the execution of the first drop processing is started in the further next fuel cell system.

In a case where a plurality of fuel cell systems are provided in parallel, when the execution of the oxygen consumption control is started simultaneously in the plurality of fuel cell systems, the generated electric power of the fuel cells easily exceeds the allowable electric power of the battery. On the other hand, in a case where the oxygen consumption control is executed in the next fuel cell system after completion of the oxygen consumption control in one fuel cell system, a long time is required until the oxygen consumption control is completed in all of the fuel cell systems, resulting in prolongation of the time required for stopping the operation of the fuel cell systems. In contrast, in the present invention, in a case where the oxygen consumption control is executed in each of the plurality of fuel cell systems, the oxygen consumption control is started in the next fuel cell system and execution of the first drop processing is started before completion of the oxygen consumption control in one fuel cell system. Therefore, it is possible to shorten the time until the oxygen consumption control is completed in all of the fuel cell systems.

A fuel cell control system according to a second aspect of the present invention is characterized in that, in the fuel cell control system according to the first aspect, the oxygen consumption control unit executes the first drop processing until the detected output voltage of the fuel cell becomes equal to or lower than the first threshold voltage, and executes the second drop processing in a case where the detected output voltage of the fuel cell is equal to or lower than the first threshold voltage and is higher than a second threshold voltage that is set to a value lower than the first threshold voltage.

With this configuration, in the fuel cell system during the execution of the oxygen consumption control, the first drop processing is executed until the output voltage becomes equal to or lower than the first threshold voltage, and in a case where the output voltage is equal to or lower than the first threshold voltage and is higher than the second threshold voltage, the second drop processing is executed. The second threshold voltage may be set to a low voltage at which the operation of the fuel cell system can be stopped. Therefore, with this configuration, in the fuel cell system during the execution of the oxygen consumption control, it is possible to shorten the time required for the oxygen consumption control while suppressing the generated electric power from becoming excessive.

A fuel cell control system according to a third aspect of the present invention is characterized to, in the fuel cell control system according to the second aspect, further include a battery capable of supplying generated electric power of the fuel cell; and an oxidant gas concentration acquisition unit that acquires an oxidant gas concentration in the fuel cell in each of the fuel cell systems, in which the oxygen consumption control unit sets voltage drop rates of the first voltage drop rate and the second voltage drop rate on the basis of at least one of a charge state of the battery and the oxidant gas concentration, and the voltage drop rate is set such that the change amount per unit time becomes smaller as the charge state becomes closer to full charge or as the oxidant gas concentration becomes higher.

With this configuration, the voltage drop rates of the first voltage drop rate and the second voltage drop rate are set on the basis of at least one of the charge state of the battery and the oxidant gas concentration, and are set such that the change rate becomes smaller as the charge state becomes closer to full charge or as the oxidant gas concentration becomes higher.

The closer the charge state of the battery is to full charge, the smaller allowable electric power of the battery becomes, and thus the possibility that the generated electric power of the fuel cell exceeds the allowable electric power of the battery increases. In addition, as the oxidant gas concentration is higher, the generated electric power tends to increase when the output voltage of the fuel cell is decreased.

In this configuration, the voltage drop rates of the first voltage drop rate and the second voltage drop rate are set such that the change rate becomes smaller as the charge state becomes closer to full charge or as the oxidant gas concentration becomes higher. Therefore, in accordance with the charge state of the battery and the oxidant gas concentration, it is possible to shorten the time required for the oxygen consumption control while suppressing the generated electric power in the fuel cell system during the execution of the oxygen consumption control from becoming excessive.

A fuel cell control system according to a fourth aspect of the present invention is characterized to, in the fuel cell control system according to the second aspect, further include a degradation state acquisition unit that acquires a degradation state of the fuel cell in each of the fuel cell systems, in which voltage drop rates of the first voltage drop rate and the second voltage drop rate are set such that the change amount per unit time becomes larger as a degradation degree indicated by the degradation state increases.

With this configuration, the voltage drop rates of the first voltage drop rate and the second voltage drop rate are set such that the change rate becomes greater as the degree of degradation of the fuel cell is larger.

In the fuel cell, the power generation capability increases as the degree of degradation is smaller, and the power generation capability gradually decreases as the degradation progresses. Therefore, even when the output voltage of the fuel cell is the same, the generated electric power differs depending on the degradation state of the fuel cell. Therefore, in a case where the degree of degradation of the fuel cell is large, it becomes possible to increase the drop rate of the output voltage of the fuel cell and thereby quickly decrease the output voltage as compared with a case where the degree of degradation is small.

In this configuration, since the degradation state of the fuel cell is monitored and the voltage drop rate is set to a larger value as the degree of degradation is larger, it is possible to shorten the time required for the oxygen consumption control while suppressing the generated electric power in the fuel cell system during the execution of the oxygen consumption control from becoming excessive, in accordance with the degradation state of the fuel cell.

A fuel cell control system according to a fifth aspect of the present invention is characterized in that, in the fuel cell control system according to the third or fourth aspect, when starting the oxygen consumption control in the one selected fuel cell system, the oxygen consumption control unit closes the cathode shutoff valve in the one selected fuel cell system, and sets the output voltage of the fuel cell in the one selected fuel cell system to a first predetermined value voltage that is higher than the first threshold voltage and lower than an open-circuit voltage.

With this configuration, at the start of the oxygen consumption control, the cathode shutoff valve is closed, and the output voltage of the fuel cell is set to the first predetermined value voltage that is higher than the first threshold voltage and lower than the open-circuit voltage. As a result, in the fuel cell having a high oxygen concentration at the start of the oxygen consumption control, by setting the fuel cell to a high-voltage state under an extremely low load, it is possible to avoid the generation of the open-circuit voltage and suppress degradation of the fuel cell while preventing the generated electric power from exceeding the allowable electric power of the battery.

A fuel cell control system according to a sixth aspect of the present invention is characterized in that, in the fuel cell control system according to the fifth aspect, the oxygen consumption control unit stops an operation of the one selected fuel cell system after the detected output voltage of the fuel cell becomes equal to or lower than the second threshold voltage.

With this configuration, since the operations of the fuel cell systems in which the output voltage of the fuel cell has become equal to or lower than the second threshold voltage can be sequentially stopped, it is possible to shorten the overall stop time of the plurality of fuel cell systems.

A fuel cell control system according to a seventh aspect of the present invention is characterized in that, in the fuel cell control system according to the sixth aspect, when the first drop processing in the one selected fuel cell system is completed, the oxygen consumption control unit closes the cathode shutoff valve and starts the oxygen consumption control in the next one of the fuel cell systems.

With this configuration, when the first drop processing in one fuel cell system is completed, the cathode shutoff valve is closed and the oxygen consumption control is started in the next fuel cell system. As described in the fifth aspect of the present invention, at the start of the oxygen consumption control, the cathode shutoff valve is closed, the output voltage of the fuel cell is set to the first predetermined value voltage, and then the first drop processing is executed. As described above, when the first drop processing in one fuel cell system is completed, the oxygen consumption control is started in the next fuel cell system, and thus a certain amount of time is provided until the first drop processing is started in the next fuel cell system. As a result, it is possible to adjust the timing such that the first drop processing is started in the next fuel cell system at a stage where the generated electric power in one fuel cell system has sufficiently decreased. Therefore, even in a case where the number of fuel cell systems performing power generation is large and the total generated electric power tends to increase, it is possible to shorten the time required for the oxygen consumption control while suppressing the overall generated electric power during the oxygen consumption control from becoming excessive. In addition, it is possible to suppress degradation of the fuel cell by shortening the time during which the output voltage of the fuel cell is maintained at the first predetermined value voltage that is a relatively high voltage.

A fuel cell control system according to an eighth aspect of the present invention is characterized in that, in the fuel cell control system according to the sixth aspect, when the first drop processing in the one selected fuel cell system is completed, the oxygen consumption control unit immediately starts the first drop processing in the next one of the fuel cell systems.

With this configuration, when the first drop processing in one fuel cell system is completed, the first drop processing is immediately started in the next fuel cell system. That is, in this configuration, before the first drop processing in one fuel cell system is completed, the closing of the cathode shutoff valve and the setting of the output voltage of the fuel cell to the first predetermined value voltage are completed in the next fuel cell system so that the first drop processing can be started. Then, when the first drop processing in one fuel cell system is completed, the first drop processing is immediately started in the next fuel cell system. Therefore, for example, in a case where the number of fuel cell systems performing power generation is small and the overall generated electric power tends not to increase, it is possible to further shorten the time required for the oxygen consumption control while suppressing the overall generated electric power during the oxygen consumption control from becoming excessive.

A fuel cell control system according to a ninth aspect of the present invention is characterized in that, in the fuel cell control system according to the sixth aspect, the number of fuel cell systems performing power generation among the plurality of fuel cell systems is smaller than a predetermined number, the cathode shutoff valve of each of all of the fuel cell systems performing power generation is closed at the time of start of the oxygen consumption control in the one selected fuel cell system, and after the first drop processing in the one selected fuel cell system is completed, execution of the first drop processing is immediately started in the next one of the fuel cell systems, and when the number of fuel cell systems performing power generation among the plurality of fuel cell systems is equal to or greater than the predetermined number, only the cathode shutoff valve of the fuel cell system in which the oxygen consumption control is started is closed, and when the first drop processing in the one selected fuel cell system is completed, the cathode shutoff valve is closed and the oxygen consumption control is started in the next one of the fuel cell systems.

With this configuration, in a case where the number of fuel cell systems performing power generation is small, the cathode shutoff valves of all of the fuel cell systems performing power generation are closed when the oxygen consumption control is started in one fuel cell system, and after the first drop processing in one fuel cell system is completed, the execution of the first drop processing is immediately started in the next fuel cell system. As a result, it is possible to shorten the time until the oxygen consumption control is completed in all of the plurality of fuel cell systems.

In addition, in a case where the number of fuel cell systems performing power generation is large, when the oxygen consumption control is started in one fuel cell system, only the cathode shutoff valve of the one fuel cell system is closed, and after the first drop processing in one fuel cell system is completed, the cathode shutoff valve of the next fuel cell system is closed, and the oxygen consumption control is started. As a result, it is possible to suppress degradation of the fuel cell by shortening the time during which the fuel cell in each fuel cell system is maintained at the first predetermined value voltage, and also to shorten the time required for the oxygen consumption control while suppressing the overall generated electric power during the oxygen consumption control from becoming excessive.

According to the present invention, it is possible to provide a fuel cell control system capable of shortening time required for oxygen consumption control while suppressing generated electric power during execution of the oxygen consumption control from becoming excessive in a plurality of fuel cell systems.

### BRIEF DESCRIPTION OF DRAWINGS

FIG. 1 is a schematic configuration diagram of a fuel cell vehicle on which a fuel cell control system according to a first embodiment of the present invention is mounted;

FIG. 2 is a schematic configuration diagram of a fuel cell system (FC system) according to the first embodiment;

FIG. 3 is a diagram illustrating a configuration of a control system of the fuel cell control system according to the first embodiment;

FIG. 4 is a timing chart illustrating an operation when an operation of the FC system according to the first embodiment is stopped;

FIG. 5 is a flowchart illustrating operation stop control processing in the fuel cell control system according to the first embodiment;

FIG. 6 is a diagram illustrating a temporal change in instantaneous generated output at a time of output voltage drop due to a difference in oxygen concentration of the fuel cell;

FIG. 7 is a diagram illustrating a change in generated electric power caused by first drop processing and second drop processing in oxygen consumption control;

FIG. 8 is a diagram illustrating execution timings of oxygen consumption control in a plurality of FC systems according to the first embodiment;

FIG. 9 is a flowchart illustrating operation stop control processing in a fuel cell control system according to a second embodiment; and

FIG. 10 is a diagram illustrating execution timing of oxygen consumption control in a plurality of FC systems according to the second embodiment.

### DETAILED DESCRIPTION

Hereinafter, preferred embodiments of a fuel cell control system of the present invention will be described in detail with reference to the drawings. A fuel cell control system according to an embodiment illustrated as an example is mounted on a fuel cell vehicle, and controls a plurality of fuel cell systems that function as one of power sources of a fuel cell vehicle. The fuel cell vehicle may be a two-wheeled vehicle, a three-wheeled vehicle, a four-wheeled vehicle, or the like. Note that the configuration described below is an example of the present invention, and the present invention is not limited thereto. For example, the fuel cell system of the present invention may be mounted on a moving body such as a ship or an airplane, in addition to a vehicle, or may be used in a stationary facility such as a house or a building.

### Outline of Fuel Cell Vehicle 100

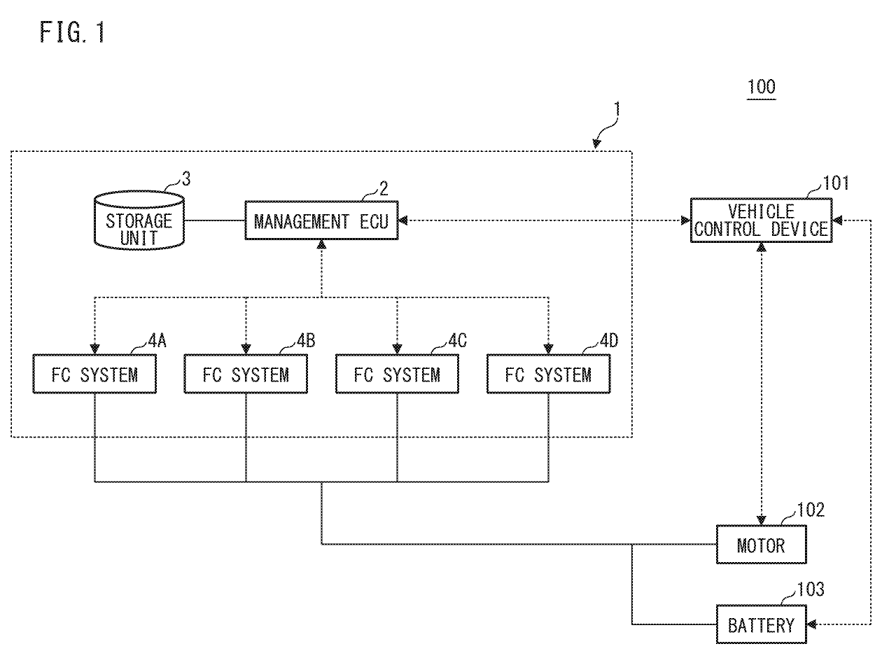

FIG. 1 is a schematic configuration diagram of a fuel cell vehicle 100 on which a fuel cell control system 1 according to the first embodiment is mounted. The fuel cell vehicle 100 is, for example, a fuel cell electric vehicle and, as illustrated in the drawing, includes the fuel cell control system 1, a vehicle control device 101, a motor 102, and a battery 103. The fuel cell control system 1 includes a management Electric Control Unit (ECU) 2, a storage unit 3, and a Fuel Cell (FC) system 4 (4A, 4B, 4C, 4D). Other constituent elements of the fuel cell vehicle 100 are omitted in the drawing.

Although four FC systems 4A, 4B, 4C, and 4D are illustrated as the FC systems 4 included in the fuel cell control system 1 in the example of FIG. 1, the number of the FC systems 4 mounted is not limited thereto, and a larger or smaller number of FC systems 4 may be mounted. In a case where individual FC systems are not distinguished, the individual FC systems may simply be referred to as the FC system 4. The FC system 4 and the management ECU 2 constitute the fuel cell control system 1 in the present embodiment. It is also possible to adopt a configuration in which the vehicle control device 101 is included as a part of the fuel cell control system.

The motor 102 is, for example, a three-phase alternating-current motor, and is driven using electric power supplied from the FC system 4 or the battery 103 as a power source. A rotor of the motor 102 is connected to a drive wheel (not illustrated), and the motor 102 outputs a driving force used for traveling of the fuel cell vehicle 100 to the drive wheel under control of the vehicle control device 101. The motor 102 also performs regenerative power generation using kinetic energy of the vehicle during deceleration of the vehicle.

The battery 103 is, for example, a secondary battery such as a lithium-ion battery. The battery 103 stores electric power generated in the FC system 4 or the motor 102, and supplies electric power for traveling of the fuel cell vehicle 100 to the motor 102 under control of the vehicle control device 101. In addition, when the FC system 4 is activated, the battery 103 supplies electric power for driving an auxiliary device of the FC system 4. In addition, after the activation of the FC system 4 is initiated, the battery 103 supplies a shortage of electric power until the generated electric power of the FC system 4 reaches required electric power.

The battery 103 is provided with sensors such as a current sensor, a voltage sensor, and a temperature sensor (that are not illustrated), and these various sensors output detected current values, voltage values, temperatures, and the like to the vehicle control device 101.

The vehicle control device 101 is, for example, an ECU configured by a microcomputer including, for example, a CPU, a RAM, a ROM, and an I/O interface (none of which are illustrated), and comprehensively controls the traveling of the fuel cell vehicle 100, the operation of an in-vehicle device (not illustrated), and the like.

The vehicle control device 101 controls the supply of electric power stored in the battery 103 and electric power generated by the FC system 4 according to the required electric power from the fuel cell vehicle 100. The required electric power from the fuel cell vehicle 100 is total load electric power required for driving or operation of the motor 102, a brake device and various sensors (not illustrated), and other in-vehicle devices and auxiliary devices.

In addition, the vehicle control device 101 may perform travelling control of the fuel cell vehicle 100, and may perform traction and regenerative driving control for the motor 102, as well as charge and discharge control for the battery 103.

The management ECU 2 is an ECU configured by a microcomputer including, for example, a CPU, a RAM, a ROM, and an I/O interface (none of which are illustrated), and comprehensively controls the plurality of FC systems 4. The management ECU 2 includes a plurality of communication interfaces corresponding to the number of plurality of FC systems 4, and each communication interface performs communication with the FC system 4 of the connection destination.

The management ECU 2 acquires an operation stop request for the FC systems 4 from the vehicle control device 101, and performs control for stopping the operation of each FC system 4 on the basis of the request. Details of such control will be described later.

The storage unit 3 is implemented by hardware such as, for example, a Hard Disk Drive (HDD), a flash memory, an Electrically Erasable Programmable Read Only Memory (EEPROM), a Read Only Memory (ROM), or a Random Access Memory (RAM). In the storage unit 3, information regarding a power generation state of each FC system 4, which is transmitted from an FC control device 60 of each FC system 4 described later, is stored.

Each of the plurality of FC systems 4 includes a fuel cell. The fuel cell is a cell that performs power generation through an electrochemical reaction between fuel gas supplied to an anode and oxidant gas supplied to a cathode. In the present embodiment, hydrogen gas is used as the fuel gas, and air containing oxygen is used as the oxidant gas.

Each FC system 4 performs power generation according to a target power generation amount determined under control of the management ECU 2, and supplies the generated electric power to the motor 102 or the battery 103 under control of the vehicle control device 101. Each FC system 4 also stops the power generation operation under control of the management ECU 2, as described later.

### Configuration of FC System 4

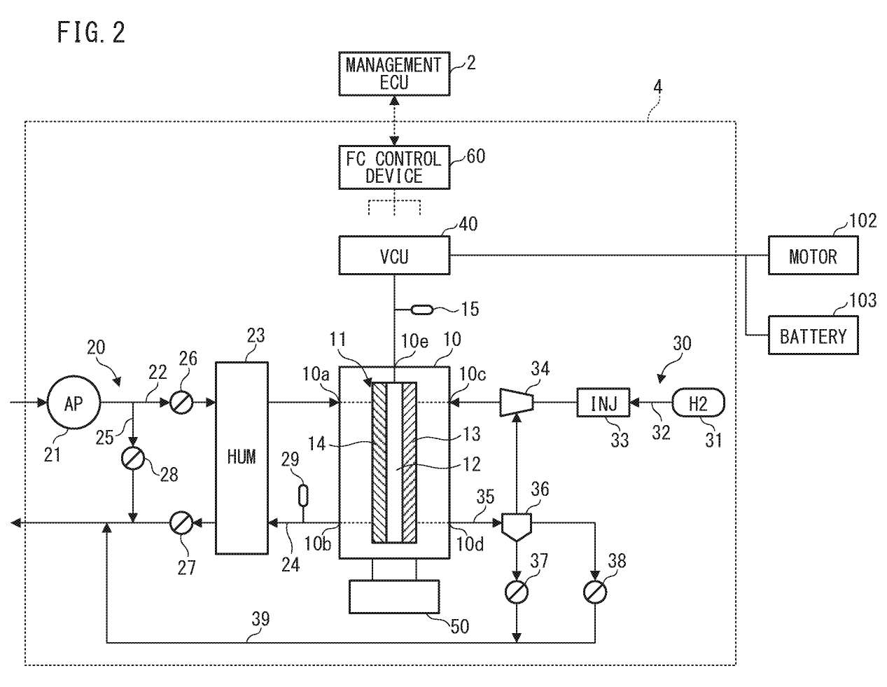

A specific configuration of the FC system 4 will be described with reference to FIG. 2. FIG. 2 is a diagram illustrating an example of a schematic configuration of the FC system 4 according to the present embodiment. The configuration illustrated in FIG. 2 can be applied to each of the plurality of FC systems 4 mounted on the fuel cell vehicle 100. Note that the configuration described below is merely an example, and any configuration may be adopted as long as the system is configured to generate electric power by an anode and a cathode.

The FC system 4 includes a fuel cell (FC) stack 10, an oxidant gas supply device 20, a hydrogen gas supply device 30, a Voltage Control Unit (VCU) 40, a cooling system 50, and the FC control device 60.

The FC stack 10 is a structure in which a plurality of power generation cells 11 are stacked. The FC stack 10 is provided with an oxidant gas inlet 10a, an oxidant gas outlet 10b, a hydrogen gas inlet 10c, a hydrogen gas outlet 10d, and an electrode 10e.

Each power generation cell 11 is a cell that performs power generation through an electrochemical reaction between hydrogen gas supplied to an anode and oxidant gas supplied to a cathode. Each power generation cell 11 has a configuration in which a solid polymer electrolyte membrane (hereinafter also simply referred to as an electrolyte membrane) 12 made of, for example, a cation exchange membrane such as a thin film of perfluorosulfonic acid containing moisture is sandwiched between an anode electrode 13 and a cathode electrode 14. As the electrolyte membrane 12, in addition to a fluorine-based electrolyte, a hydrocarbon-based electrolyte or the like can be used.

Hydrogen gas as the fuel gas is supplied to the anode electrode 13 from the hydrogen gas supply device 30. Air as the oxidant gas is supplied to the cathode electrode 14 from the oxidant gas supply device 20. Hydrogen in the hydrogen gas supplied to the anode electrode 13 is ionized through a catalytic reaction on an anode catalyst (not illustrated), and the generated hydrogen ions pass through the electrolyte membrane 12 and move to the cathode electrode 14. Electrons released in association with ionization of hydrogen move through the electrode 10e to an external circuit, thereby generating a current, and power generation is thus performed. Hydrogen ions that have moved from the anode electrode 13 to the cathode electrode 14 react with oxygen in the oxidant gas supplied to the cathode electrode 14 to produce water.

The oxidant gas supply device 20 includes an air pump 21 that compresses air from the atmosphere and supplies the compressed air to the FC stack 10, and the air pump 21 is disposed in an oxidant gas supply passage 22. The air pump 21 is driven by an actuator (not illustrated), and a rotational speed of the air pump 21 is controlled by the FC control device 60. The rotational speed of the air pump 21 is detected by a rotational speed sensor (not illustrated), and a detection signal thereof is sequentially transmitted to the management ECU 2 via the FC control device 60.

A humidifier 23 is provided on a downstream side of the air pump 21 in the oxidant gas supply passage 22. The oxidant gas supply passage 22 is connected, on a downstream side of the humidifier 23, to the oxidant gas inlet 10a of the FC stack 10.

The oxidant gas supply passage 22 is also connected to a bypass flow passage 25 that branches from the oxidant gas supply passage 22 and communicates with an oxidant gas discharge passage 24, described later, while bypassing the FC stack 10. A bypass valve 28 is provided in the bypass flow passage 25. The bypass valve 28 is configured to adjust a flow rate of oxidant gas flowing through the bypass flow passage 25 in accordance with the opening degree thereof. The opening degree of the bypass valve 28 is controlled by the FC control device 60 or the management ECU 2.

The oxidant gas outlet 10b is connected to the oxidant gas discharge passage 24. The oxidant gas discharge passage 24 communicates, after passing through the humidifier 23, with the outside of the FC system 4, and releases off-gas (cathode off-gas) of the oxidant gas that has passed through the FC stack 10, to the outside. The oxidant gas discharge passage 24 may, for example, communicate with the outside of the fuel cell vehicle 100 and be configured to discharge the cathode off-gas into the atmosphere. An oxygen sensor 29 is disposed in the oxidant gas discharge passage 24. The oxygen sensor 29 detects an oxygen concentration in the cathode off-gas, and a detection signal thereof is sequentially transmitted to the management ECU 2 via the FC control device 60.

The humidifier 23 recovers moisture from the cathode off-gas discharged from the oxidant gas outlet 10b and passing through the oxidant gas discharge passage 24, and humidifies the oxidant gas flowing through the oxidant gas supply passage 22 using the moisture. As a result, the electrolyte membrane 12 in each power generation cell 11 of the FC stack 10 can be maintained at humidity suitable for power generation.

On a downstream side of the air pump 21 in the oxidant gas supply passage 22, a supply-side shutoff valve 26 is provided. The supply-side shutoff valve 26 opens and closes under control of the FC control device 60 or the management ECU 2, and thereby opening and closing of the oxidant gas supply passage 22 is switched.

A discharge-side shutoff valve 27 is provided on a downstream side of the humidifier 23 in the oxidant gas discharge passage 24. The discharge-side shutoff valve 27 opens and closes under control of the FC control device 60 or the management ECU 2, and thereby opening and closing of the oxidant gas discharge passage 24 is switched.

The hydrogen gas supply device 30 includes a hydrogen tank 31 that stores high-pressure hydrogen gas. The hydrogen tank 31 communicates with the hydrogen gas inlet 10c of the FC stack 10 via a hydrogen gas supply passage 32. An injector 33 and an ejector 34 are provided in series in the hydrogen gas supply passage 32.

The opening degree of the injector 33 is controlled by the FC control device 60, thereby defining a flow rate and supply timing of hydrogen gas supplied to the FC stack 10. The ejector 34 draws a portion of off-gas (anode off-gas) of the hydrogen gas discharged from the hydrogen gas outlet 10d through a hydrogen gas discharge passage 35 and recirculates the portion of off-gas into the hydrogen gas supply passage 32 by generating a negative pressure inside.

The hydrogen gas discharge passage 35 communicates with the hydrogen gas outlet 10d of the FC stack 10, and a gas-liquid separator 36 is connected to the hydrogen gas discharge passage 35.

The gas-liquid separator 36 separates the anode off-gas discharged from the hydrogen gas outlet 10d of the FC stack 10 into a gas component and a liquid component. The liquid component separated from the anode off-gas is discharged to a purge flow passage 39 through a drain valve 37 of which opening and closing are controlled by the FC control device 60. In addition, a part of the gas component separated from the anode off-gas is recirculated through the ejector 34, and another part thereof is discharged to the purge flow passage 39 through a purge valve 38 of which opening and closing are controlled by the FC control device 60.

The purge flow passage 39 is a flow passage for discharging the anode off-gas to the outside and joins the oxidant gas discharge passage 24 at a most downstream side thereof. The anode off-gas flowing through the purge flow passage 39 is diluted by being mixed with the cathode off-gas flowing through the oxidant gas discharge passage 24, and is discharged to the outside in a state where the hydrogen concentration is reduced to a value equal to or lower than a prescribed value.

It is also possible to adopt a configuration in which a diluter is separately provided on a downstream side of a junction between the oxidant gas discharge passage 24 and the purge flow passage 39, to more reliably dilute the anode off-gas.

The VCU 40 is, for example, a step-up type DC-DC converter. The VCU 40 is disposed between the anode electrode 13 and the cathode electrode 14 of the FC stack 10 and an external electrical load of the FC system 4.

The VCU 40 has a function of boosting an output voltage to a desired voltage when electric power generated by the FC stack 10 is supplied to loads such as the motor 102, the battery 103, the air pump 21, or other various auxiliary devices.

A voltage sensor 15 that detects an output voltage of the FC stack 10 is disposed between the VCU 40 and the FC stack 10. The detection signal of the voltage sensor 15 is sequentially transmitted to the management ECU 2 via the FC control device 60.

The cooling system 50 performs cooling of the FC stack 10 under control of the FC control device 60. For example, the cooling system 50 includes a radiator and a water pump (none of which are illustrated), and cools the FC stack 10 by circulating a coolant such as pure water or ethylene glycol through a coolant flow passage (not illustrated) provided in the FC stack 10.

The FC control device 60 is an ECU configured by a microcomputer including a CPU, a RAM, a ROM, and an I/O interface (none of which are illustrated), and is provided in each FC system 4.

The FC control device 60 is configured to be capable of acquiring information regarding a power generation state of the FC system 4 to which the FC control device 60 belongs, on the basis of detection values from various sensors, either illustrated or not illustrated. Each FC control device 60 continuously acquires information regarding a state of the FC system 4, or acquires the information in response to a request from the management ECU 2, and transmits the acquired information to the management ECU 2. Examples of the state of the FC system 4 to be acquired include a current power generation condition of the FC stack 10, generated electric power, power generation time, and output voltage or the like. The FC control device 60 also calculates a degradation state of the FC stack 10 on the basis of the power generation condition of the FC stack 10 (for example, an actual power generation amount relative to a target power generation amount). Information on the calculated degradation state is transmitted to the management ECU 2 as one of the pieces of information regarding the state of the FC stack 10.

The FC control device 60 controls starting and stopping of power generation, a power generation amount, and the like in the FC system 4 under control of the management ECU 2. The FC control device 60 also performs control such as opening and closing control of various valves in the FC system 4, driving control of various auxiliary devices (such as the air pump 21), and output voltage control of the FC stack 10 via the VCU 40. In addition, the FC control device 60 controls a supply amount and supply timing of hydrogen gas supplied to the FC stack 10 by controlling an opening degree of the injector 33 while referring to a value of a pressure sensor (not illustrated) that is provided, for example, in the hydrogen gas supply passage 32 or the like and detects the pressure of hydrogen gas. Furthermore, the FC control device 60 activates the cooling system 50 and performs control regarding the temperature adjustment of the FC stack 10.

The FC control device 60 may also perform charge and discharge control for the battery 103 and traction and regenerative driving control for the motor 102 in coordination with the management ECU 2 and the vehicle control device 101.

### Power Generation Operation of FC System 4

A power generation operation of the FC system 4 configured as described above (a power generation operation in the FC stack 10) will be described below.

The oxidant gas supply device 20 supplies air as oxidant gas to the oxidant gas supply passage 22 via the air pump 21. The oxidant gas is humidified while passing through the humidifier 23, and is then supplied to the FC stack 10 through the oxidant gas inlet 10a.

On the other hand, the hydrogen gas supply device 30 supplies hydrogen gas as fuel gas from the hydrogen tank 31 to the hydrogen gas supply passage 32 on the basis of the opening degree control of the injector 33 by the FC control device 60. The hydrogen gas passes through the ejector 34, and is supplied to the FC stack 10 through the hydrogen gas inlet 10c.

The oxidant gas supplied to the FC stack 10 through the oxidant gas inlet 10a is supplied to the cathode electrode 14 of each power generation cell 11. On the other hand, the hydrogen gas supplied to the FC stack 10 through the hydrogen gas inlet 10c is supplied to the anode electrode 13 of each power generation cell 11. As a result, in each power generation cell 11, hydrogen and oxygen in the oxidant gas are consumed through an electrochemical reaction, and power generation is performed.

Electric power generated by the power generation is supplied to the motor 102, the battery 103, various other auxiliary devices, and the like via the VCU 40 under control of the FC control device 60.

The cathode off-gas at the cathode electrode 14 of each power generation cell 11 is discharged to the oxidant gas discharge passage 24 through the oxidant gas outlet 10b. The discharged cathode off-gas is discharged to the outside after moisture is recovered when passing through the humidifier 23. The moisture recovered by the humidifier 23 is, as described above, used for humidifying the oxidant gas flowing through the oxidant gas supply passage 22, thereby adjusting humidity of the electrolyte membrane 12 in each power generation cell 11 of the FC stack 10.

In addition, the anode off-gas at the anode electrode 13 of each power generation cell 11 is discharged to the hydrogen gas discharge passage 35 through the hydrogen gas outlet 10d. The discharged anode off-gas is introduced from the hydrogen gas discharge passage 35 into the gas-liquid separator 36, where liquid moisture is separated. Thereafter, a gas component of the anode off-gas is either recirculated through the ejector 34 or merged into the oxidant gas discharge passage 24 through the purge flow passage 39, is mixed and diluted with the cathode off-gas, and then is discharged to the outside.

During the execution of the series of power generation operations described above, under control of the FC control device 60, the cooling system 50 operates in accordance with the temperature of the FC stack 10, thereby cooling the FC stack 10.

### Configuration of Management ECU 2

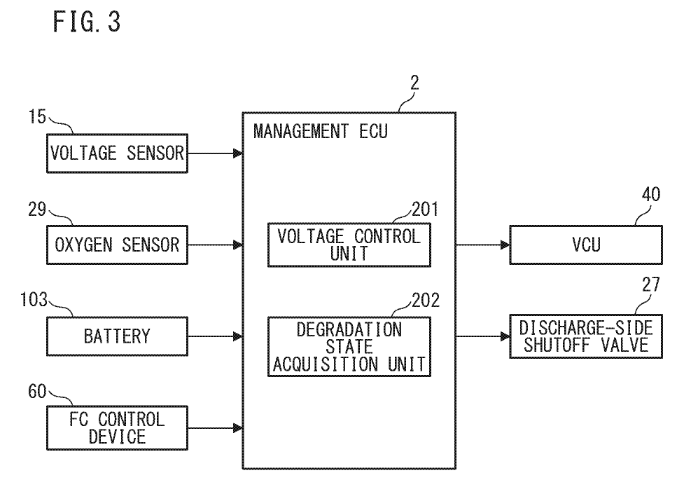

Next, a configuration of the management ECU 2 of the fuel cell control system 1 will be described. As illustrated in FIG. 3, the management ECU 2 includes a voltage control unit 201 and a degradation state acquisition unit 202, and functions as an oxygen consumption control unit that executes oxygen consumption control in the FC system 4 described later. These functional units are implemented, for example, by a hardware processor such as a CPU of the management ECU 2 reading and executing a program (software). Such a program may be stored in a ROM or a RAM included in the management ECU 2, or may be stored in a storage device (a storage device including a non-transitory storage medium such as an HDD or a flash memory) constituting the storage unit 3.

The voltage control unit 201 controls an output voltage of the FC stack 10 in each FC system 4 via the VCU 40 of the corresponding FC system 4.

The degradation state acquisition unit 202 acquires a degradation state of the FC stack 10 in each FC system 4, which is received from the FC control device 60 of each FC system 4 and stored in the storage unit 3.

The management ECU 2, using the voltage control unit 201 and the degradation state acquisition unit 202, functions as the oxygen consumption control unit, and executes oxygen consumption control for consuming oxygen remaining in the FC stack 10 to prevent degradation of the FC stack 10 during operation stop control for stopping the operation of the FC system 4. As described later, in the oxygen consumption control, the management ECU 2 monitors an output voltage of the FC stack 10 on the basis of a detection signal from the voltage sensor 15, and decreases the output voltage of the FC stack 10 at a plurality of voltage drop rates corresponding to the detected output voltage. In addition, as described later, each voltage drop rate is determined on the basis of any one or a combination of an oxygen concentration in the FC stack 10 detected by the oxygen sensor 29, a charge state of the battery 103, and a degradation state of the FC stack 10 acquired from the FC control device 60.

### Outline of Operation Stop Control of FC System 4

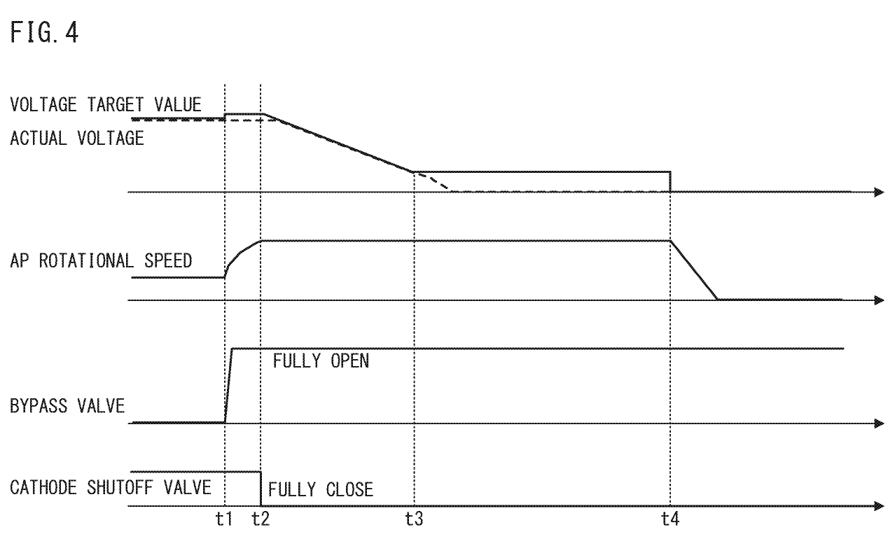

Next, an outline of an operation when the operation of each FC system 4 is stopped will be described. When an operation stop request for the FC system 4 is transmitted from the vehicle control device 101 to the management ECU 2, the management ECU 2 sequentially executes operation stop control for the stop operation of each of the plurality of FC systems 4. FIG. 4 illustrates an outline of the operation of the FC system 4 at this time. Oxygen consumption control is executed between a time point t1 and a time point t3 in the drawing, and details of the control will be described later.

When stopping the operation of the plurality of FC systems 4, it is necessary, from the viewpoint of preventing degradation of the FC stack 10, to achieve two objectives of decreasing an output voltage of the FC stack 10 in each FC system 4 as soon as possible to a level at which operation can be stopped, and of consuming oxygen remaining in the FC stack 10 as soon as possible. In addition, it is also necessary to ensure a state in which the anode off-gas can be discharged after being diluted with an appropriate amount of cathode off-gas or oxidant gas so that the hydrogen concentration is reduced to a value equal to or lower than a prescribed value.

Immediately after the start of operation stop control, since the oxygen concentration in the FC stack 10 (cathode electrode 14) is high and the FC stack 10 is in a state of high power generation capability, generated electric power tends to increase by lowering the output voltage of the FC stack 10. The generated electric power of the FC system 4 is supplied to the battery 103, but there is an upper limit to the electric power that can be supplied to the battery 103 due to the charging characteristics on the battery 103 side. Therefore, the generated electric power of the FC stack 10 needs to be limited to a certain value or lower so as not to exceed allowable electric power of the battery 103. Therefore, when decreasing an output voltage of the FC stack 10, there is a constraint that the generated electric power is suppressed to be equal to or lower than allowable electric power of the battery. A constant value for ensuring that the generated electric power of the FC stack 10 does not exceed allowable electric power of the battery 103 may be set on the basis of preliminary testing or simulation.

The oxygen consumption control executed in the present embodiment is executed for the purpose of shortening the time required for the oxygen consumption control while suppressing the generated electric power of the FC stack 10 from becoming excessive in the plurality of FC systems 4 provided in parallel.

At time point t1, the voltage control unit 201 of the management ECU 2 controls, via the VCU 40, the output voltage of the FC stack 10 to a first predetermined value voltage Vₚ, which is a voltage close to an open-circuit voltage of the FC stack 10 described later. Immediately after the start of the operation stop sequence of the FC system 4, the oxygen concentration in the cathode electrode 14 is high, but by controlling the output voltage to the first predetermined value voltage Vₚ, which is a high voltage under an extremely low load, it is possible to start consumption of oxygen in the cathode electrode 14 while preventing generated electric power from exceeding allowable electric power of the battery.

At time point t1, simultaneously with the voltage control described above, control is performed to increase the rotational speed of the air pump 21 and to fully open the opening degree of the bypass valve 28 provided in the bypass flow passage 25. As a result, most of the oxidant gas with an increased supply amount flows into the oxidant gas discharge passage 24 through the bypass flow passage 25. This causes the anode off-gas flowing into the oxidant gas discharge passage 24 through the purge flow passage 39 to be diluted, thereby reducing the hydrogen concentration to a value equal to or lower than a prescribed value.

Subsequently, at time point t2, the discharge-side shutoff valve 27, which is a shutoff valve on the cathode side, is closed, and the output voltage of the FC stack 10 starts to decrease. Details of the voltage drop processing at this time will be described later. The timing of closing the discharge-side shutoff valve 27 is not limited to time point t2 and may, for example, be the same as time point t1, or any timing between time point t1 and time point t2, or may be earlier than time point t1 after an operation stop request has been received.

Thereafter, the output voltage of the FC stack 10 continues to decrease, and at time point t3, when the output voltage of the FC stack 10 reaches a second threshold voltage Vₜₕ₂ described later, the drop processing of the output voltage of the FC stack 10 is completed. Subsequently, at time point t4, operation stop of the FC system 4 is completed.

### Details of Operation Stop Control

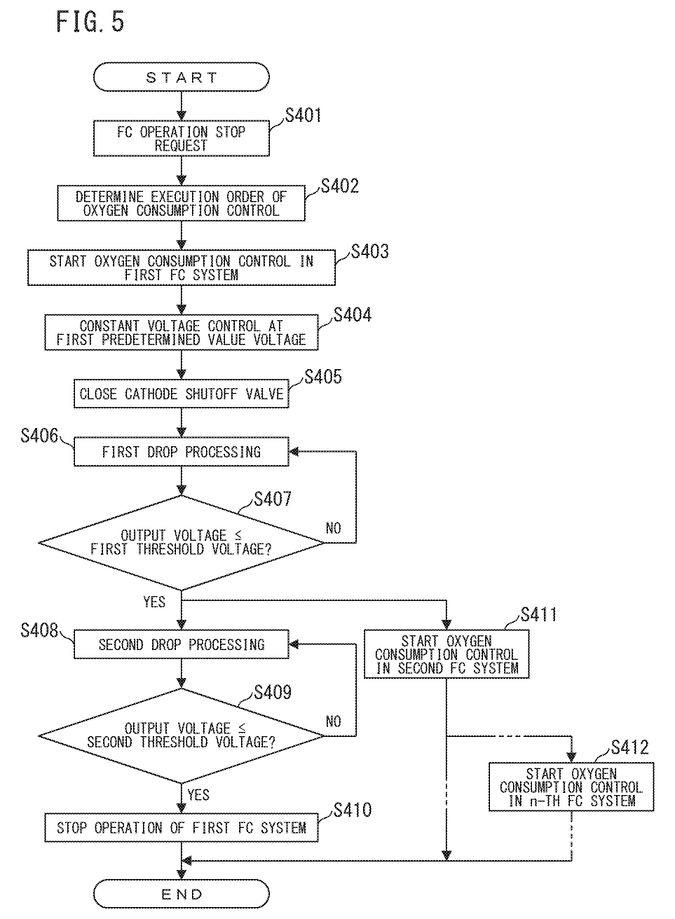

Next, details of the operation stop control including the oxygen consumption control performed between time point t1 and time point t3 in FIG. 4 will be described with reference to FIGS. 5-8.

FIG. 5 is a flowchart illustrating control processing of the operation stop control performed by the fuel cell control system 1 according to the present embodiment.

In this control processing, first, in step 401 (illustrated as “S401”, the same applies hereinafter), the management ECU 2 receives an operation stop request for the plurality of FC systems 4 from the vehicle control device 101. The operation stop request for the FC system 4 may be issued, for example, when an ignition switch of the fuel cell vehicle 100 is turned off, or may be issued according to a charge state of the battery 103 or an operating state of the fuel cell vehicle 100.

In subsequent step 402, an order for executing the oxygen consumption control in the plurality of FC systems 4 is determined. The execution order may be, for example, an order of numbers conveniently assigned to the respective FC systems 4 (for example, the order of 4A to 4D), or an order according to the degrees of degradation of the respective FC systems 4.

Subsequently, in step 403, on the basis of the execution order determined in step 402, execution of the oxygen consumption control is started in the FC system 4 of which the execution order is first (hereinafter conveniently referred to as the first FC system).

In subsequent step 404, in the first FC system 4, constant voltage control is performed to control an output voltage of the FC stack 10 to the first predetermined value voltage Vₚ that is higher than a first threshold voltage Vₜₕ₁ described later and is lower than an open-circuit voltage. As a result, oxygen remaining in the cathode electrode 14 reacts with hydrogen, which has passed through the electrolyte membrane 12 from the anode electrode 13 and has reached the cathode electrode 14, to generate power, thereby initiating consumption of oxygen in the cathode electrode 14. In the subsequent step, in order to reduce the oxygen concentration in the cathode electrode 14 to a level at which the output voltage of the FC stack 10 can start to decrease, the constant voltage control using the first predetermined value voltage Vₚ is continued for a predetermined time (for example, several seconds to several tens of seconds). This predetermined time can be set to an appropriate time derived from experiments or simulations.

At this time, as described above, by fully opening the bypass valve 28 and simultaneously increasing the rotational speed of the air pump 21, a sufficient amount of oxidant gas is supplied to the oxidant gas discharge passage 24 to dilute the anode off-gas.

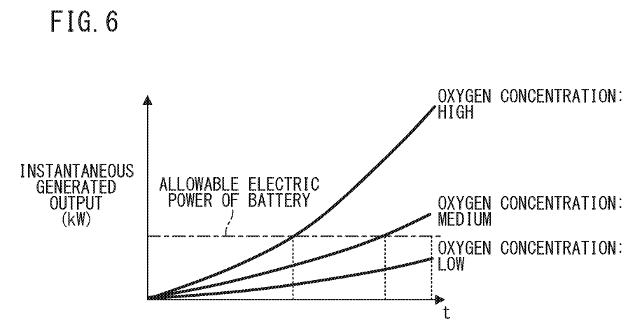

After step 404 is continued for a predetermined time, processing of decreasing the output voltage of the FC stack 10 is performed in the subsequent step. FIG. 6 is a diagram illustrating a temporal change in instantaneous generated electric power for each oxygen concentration in the FC stack 10 (in the cathode electrode 14) when the output voltage of the FC stack 10 is decreased at a constant voltage drop rate. As illustrated in the drawing, in a case where the output voltage is decreased at a constant voltage drop rate, the higher the oxygen concentration, the more quickly the instantaneous generated output exceeds a value set as allowable electric power of the battery. Therefore, in order to decrease the output voltage in as short a time as possible while keeping the generated electric power smaller than allowable electric power of the battery, it is desirable to perform control such that, when the oxygen concentration in the FC stack 10 is high, the output voltage is decreased at a voltage drop rate having a small change amount (drop amount) per unit time, that is, a small change (drop) rate, and as the oxygen concentration decreases, the output voltage is decreased at a voltage drop rate having a larger change rate.

From such a viewpoint, in the oxygen consumption control of the present embodiment, the output voltage is decreased at a voltage drop rate having a smaller change rate when the oxygen concentration in the FC stack 10 is high in an early stage of the control start, and when the output voltage has become equal to or lower than a predetermined threshold, it is determined that the oxygen concentration has decreased, and control is performed to decrease the output voltage at a voltage drop rate having a larger change rate. The specific processing steps will be described below.

First, in step 405, the discharge-side shutoff valve 27 serving as a cathode shutoff valve is closed so that the oxygen consumption control can be completed in a shorter time. As a result, since flows of the oxidant gas and the cathode off-gas from the oxidant gas outlet 10b of the FC stack 10 toward the oxidant gas discharge passage 24 are stopped, supply of the oxidant gas from the oxidant gas supply passage 22 to the FC stack 10 is also stopped. It is also possible to adopt a configuration in which the supply-side shutoff valve 26 is closed instead of the discharge-side shutoff valve 27. In addition, it is possible to adopt a configuration in which both the discharge-side shutoff valve 27 and the supply-side shutoff valve 26 are closed. As described above, closing of the cathode shutoff valve in step 405 may be performed before the completion or before the start of step 404.

Next, in step 406, since the current output voltage of the FC stack 10 is controlled to Vₚ and the oxygen concentration in the cathode electrode 14 is still high, first drop processing is executed to decrease the output voltage of the FC stack 10 at a first voltage drop rate set to a smaller change rate.

Subsequently, in step 407, it is determined whether or not the current output voltage of the FC stack 10 is equal to or lower than the first threshold voltage Vₜₕ₁. Here, the first threshold voltage Vₜₕ₁ is set to a voltage value higher than an output voltage (for example, approximately 0.6 to 0.8 V) during the normal power generation operation of the FC stack 10.

In a case where the determination result in step 407 is NO, that is, in a case where the output voltage of the FC stack 10 is higher than the first threshold voltage Vₜₕ₁, it is determined that the oxygen concentration in the cathode electrode 14 is still at a high level, and the first drop processing is continuously performed.

On the other hand, in a case where the determination result in step 407 is YES, that is, in a case where the output voltage of the FC stack 10 has become equal to or lower than the first threshold voltage Vₜₕ₁, the processing proceeds to step 408.

In step 408, it is determined that the oxygen concentration in the cathode electrode 14 has decreased to some extent and that it has become possible to decrease the output voltage of the FC stack 10 at a voltage drop rate having a larger change rate, and second drop processing is executed to decrease the output voltage of the FC stack 10 at a second voltage drop rate set to a larger change rate than the first voltage drop rate.

Subsequently, in step 409, it is determined whether or not the current output voltage of the FC stack 10 is equal to or lower than the second threshold voltage Vₜₕ₂. Here, the second threshold voltage Vₜₕ₂ is set to a voltage value low enough to allow stopping of the operation of the FC system 4. The second threshold voltage Vₜₕ₂ can be set, for example, to approximately 0.05 to 0.1 V.

In a case where the determination result in step 409 is NO, that is, in a case where the output voltage of the FC stack 10 is higher than the second threshold voltage Vₜₕ₂, it is determined that the oxygen concentration in the cathode electrode 14 has not yet sufficiently decreased, and the second drop processing is continuously performed.

On the other hand, in a case where the determination result in step 409 is YES, that is, in a case where the output voltage of the FC stack 10 has become equal to or lower than the second threshold voltage Vₜₕ₂, it is determined that the oxygen concentration in the cathode electrode 14 has sufficiently decreased and that the oxygen consumption control can be terminated, and the processing proceeds to step 410.

In step 410, after it is confirmed that other operation stop conditions (for example, completion of hydrogen gas purging) have been satisfied, the operation of the first FC system 4 is stopped, and the present control processing is completed.

Specific values of the first voltage drop rate and the second voltage drop rate used in the oxygen consumption control of the present embodiment can be specifically set on the basis of, for example, a charge state of the battery 103 acquired via the vehicle control device 101, and an oxygen concentration (oxidant gas concentration) detected by the oxygen sensor 29. The closer the charge state of the battery 103 is to full charge, the smaller allowable electric power of the battery becomes, and thus the possibility that the generated electric power of the FC stack 10 exceeds the allowable electric power of the battery increases. In addition, as the oxygen concentration of the FC stack 10 is higher, the generated electric power tends to increase when the output voltage of the FC stack 10 is decreased. Therefore, by setting change rates of the first voltage drop rate and the second voltage drop rate to be smaller as the charge state of the battery 103 becomes closer to full charge or as the oxygen concentration becomes higher, it is possible to shorten the time required for the oxygen consumption control while suppressing the generated electric power during the execution of the oxygen consumption control from becoming excessive.

Specific values of the first voltage drop rate and the second voltage drop rate may also be set on the basis of a degradation state of the FC stack 10 acquired by the degradation state acquisition unit 202. In the FC stack 10, the power generation capability increases as the degree of degradation is smaller, and the power generation capability gradually decreases as the degradation progresses. Therefore, by setting change rates of the first voltage drop rate and the second voltage drop rate to be larger as the degree of degradation of the FC stack 10 is larger, it is possible to shorten the time required for the oxygen consumption control while suppressing the generated electric power during the execution of the oxygen consumption control from becoming excessive.

In a case where the first voltage drop rate and the second voltage drop rate are set on the basis of the charge state of the battery 103, the oxygen concentration of the FC stack 10, and/or the degradation state of the FC stack 10, it is possible to adopt a configuration in which optimal voltage drop rates corresponding to the charge state of the battery 103, the oxygen concentration of the FC stack 10, and/or the degradation state of the FC stack 10 are calculated in advance by experiments or simulations, are stored as a map or a table in the storage unit 3, and are retrieved as necessary. It is also possible to adopt a configuration in which an optimal voltage drop rate is derived by calculation on the basis of the acquired charge state of the battery 103, the acquired oxygen concentration of the FC stack 10, and/or the acquired degradation state of the FC stack 10.

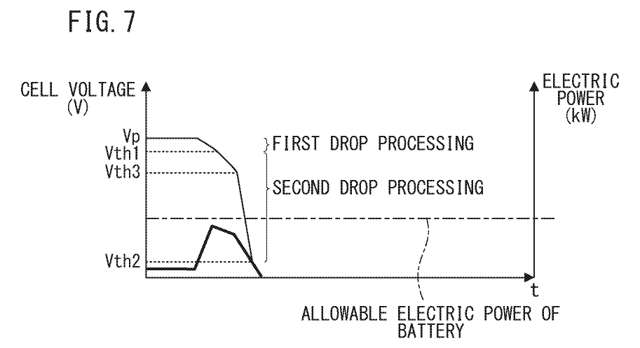

FIG. 7 is a diagram illustrating a change in generated electric power caused by the first drop processing and the second drop processing in the oxygen consumption control. As illustrated in the drawing, in a case where the first drop processing is executed to decrease the output voltage at the first voltage drop rate from a state in which the output voltage of the FC stack 10 is controlled to the first predetermined value voltage Vₚ, the generated electric power increases; however, the first voltage drop rate is set such that the generated electric power does not exceed the allowable electric power of the battery. Thereafter, at the timing when the output voltage has become equal to or lower than the first threshold voltage Vₜₕ₁, the second drop processing is executed to decrease the output voltage at the second voltage drop rate. At this stage, since the oxygen concentration in the FC stack 10 has decreased to some extent, even in a case where the output voltage is decreased at the second voltage drop rate having a larger change rate, the generated electric power does not increase and continues to decrease.

In the example of FIG. 7, the second drop processing is divided into two stages, and at the timing when the output voltage has become equal to or lower than a third threshold voltage Vₜₕ₃, which is set to a value smaller than the first threshold voltage Vₜₕ₁ and larger than the second threshold voltage Vₜₕ₂, the voltage drop rate switches to a third voltage drop rate having a larger change rate than the second voltage drop rate, thereby further shortening the time required for the oxygen consumption control. As described above, it is also possible to adopt a configuration in which the first drop processing or the second drop processing is divided into multiple stages according to the output voltage, and the output voltage is decreased using further subdivided voltage drop rates.

As described above, in the operation stop control of the present embodiment, by decreasing the output voltage using a plurality of voltage drop rates corresponding to the output voltage of the FC stack 10, it is possible to appropriately prevent the generated electric power during the oxygen consumption control from becoming excessive and exceeding allowable electric power of the battery, and to shorten the time required for the oxygen consumption control by quickly decreasing the output voltage of the FC stack 10.

Returning to FIG. 5, in the operation stop control of the present embodiment, as described in steps 401 to 410, in the oxygen consumption control performed in one selected FC system 4 (first FC system 4), it is possible to quickly decrease the output voltage while preventing generated electric power from becoming excessive. Furthermore, through the processing illustrated in steps 411 and 412, it becomes possible to shorten the overall time required for the operation stop control while preventing the generated electric power during the oxygen consumption control from becoming excessive across all of the plurality of FC systems 4. The specific control will be described below.

In a case where the determination result in step 407 is YES and the output voltage of the FC stack 10 in the first FC system 4 has become equal to or lower than the first threshold voltage Vₜₕ₁, it is determined that the oxygen concentration in the cathode electrode 14 in the first FC system 4 has decreased to some extent. At this timing, as step 411, execution of the oxygen consumption control is started in the FC system 4 of which the execution order of the oxygen consumption control is second (hereinafter conveniently referred to as a second FC system, the same applies hereinafter). Since subsequent control processing in the second FC system 4 is substantially identical to the processing of steps 404 to 410 in the first FC system 4, illustration thereof is omitted.

Similarly, at the timing when the result of the determination processing corresponding to step 407 in the second FC system 4 is YES and the first drop processing in the second FC system 4 is completed, execution of the oxygen consumption control is started in a third FC system 4. In the same manner, the execution of oxygen consumption control is started in the n-th FC system 4 (step 412), and by stopping the operation of the n-th FC system 4 through the processing corresponding to step 410, the operation of all the FC systems 4 is stopped, and the present processing is completed.

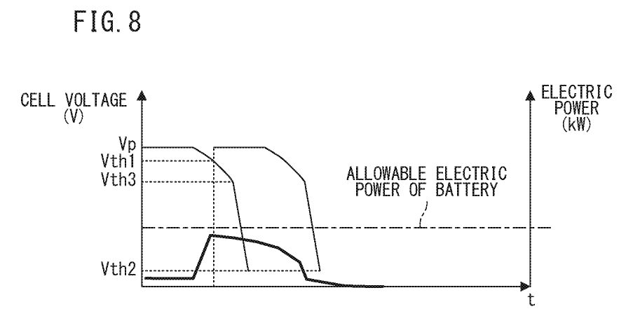

FIG. 8 illustrates execution timings of the oxygen consumption control in the plurality of FC systems 4 according to the present embodiment. For convenience, only execution timings of the oxygen consumption control in the first FC system 4 and the second FC system 4 are illustrated, but the execution timings in the third and subsequent FC systems 4 are the same.

As illustrated in the drawing, at the timing when the first drop processing is completed in the first FC system 4 and the processing transitions to the second drop processing, constant voltage control at the first predetermined value voltage and closing of the cathode shutoff valve are executed in the second FC system 4, and then, the first drop processing and the second drop processing are sequentially executed. Since the constant voltage control in the second FC system 4 is started when the second drop processing is started in the first FC system 4, total generated electric power of the first FC system 4 and the second FC system 4 combined becomes higher than that in the case of only the first FC system 4 as illustrated in FIG. 7, but the second voltage drop rate of the first FC system 4 is set such that even in this case, the generated electric power does not exceed the allowable electric power of the battery. In addition, at the timing when the first drop processing is started in the second FC system 4, the output voltage in the first FC system 4 has already sufficiently decreased, and thus the generated electric power does not become excessive thereafter. The first voltage drop rate and the second voltage drop rate in the first FC system 4 may be the same as, or different from, the first voltage drop rate and the second voltage drop rate in the second FC system 4.

As described above, in the present embodiment, execution timings of oxygen consumption control of the respective FC systems 4 are overlapped such that, instead of starting oxygen consumption control in the second FC system 4 after completion of oxygen consumption control in the first FC system 4, oxygen consumption control in the second FC system 4 is started at a stage where the first drop processing in the first FC system 4 is completed, and thus it is possible, across all of the plurality of FC systems 4, to shorten the overall time required for the operation stop control while preventing generated electric power during the oxygen consumption control from becoming excessive.

### Effects of First Embodiment

Hereinafter, effects of the present embodiment will be described.

The fuel cell control system 1 of the present embodiment includes the management ECU 2 that executes oxygen consumption control in which, during operation stop of the plurality of FC systems 4 provided in parallel, the power generation of the FC stack 10 in each FC system 4 is continued in a state where the cathode shutoff valve is closed, to consume oxygen remaining in the FC stack 10. During the operation stop of the plurality of FC systems 4, in a case where the output voltage of the FC stack 10 detected in the first FC system 4 is higher than the first threshold voltage Vₜₕ₁, which is higher than the output voltage during normal power generation, the management ECU 2 executes the first drop processing for decreasing the output voltage of the FC stack 10 in the first FC system 4 at the first voltage drop rate. In addition, in a case where the output voltage of the FC stack 10 has become equal to or lower than the first threshold voltage Vₜₕ₁, the second drop processing of decreasing the output voltage of the FC stack 10 in the first FC system 4 at the second voltage drop rate having a larger change amount per unit time than the first voltage drop rate is executed. In a case where the first drop processing in one FC system 4 is completed, execution of the first drop processing is started in the next one FC system 4.

In the fuel cell control system 1, during a high-voltage period in an early stage of the oxygen consumption control, the first drop processing of decreasing the output voltage at the first voltage drop rate having a relatively small change rate is executed. In addition, at a stage where residual oxygen decreases and power generation capability of the FC stack 10 gradually decreases, the second drop processing of decreasing the output voltage at the second voltage drop rate, which is set to a larger change rate than the first voltage drop rate, is executed. In this manner, in the fuel cell control system 1, the output voltage is decreased using different voltage drop rates depending on the output voltage of the FC stack 10. As a result, in each FC system 4, it is possible to decrease the output voltage of the FC stack 10 more quickly while preventing the generated electric power during the execution of the oxygen consumption control from exceeding the allowable electric power of the battery, and it is possible to shorten the time required for the oxygen consumption control.

In the fuel cell control system 1 of the present embodiment, at a stage where the first drop processing in one FC system 4 is completed and the processing transitions to the second drop processing, oxygen consumption control is started in the next FC system 4, and execution of the first drop processing is started. In addition, at a stage where the first drop processing in the next FC system 4 is completed, oxygen consumption control is started in a further subsequent FC system 4, and execution of the first drop processing is started. As a result, across all of the plurality of FC systems 4, it is possible to shorten the time until oxygen consumption control is completed in all of the FC systems 4 while preventing the generated electric power during the execution of the oxygen consumption control from becoming excessive.

In the fuel cell control system 1, the management ECU 2 executes the first drop processing until the output voltage of the FC stack 10 becomes equal to or lower than the first threshold voltage Vₜₕ₁, and executes the second drop processing in a case where the output voltage of the FC stack 10 is equal to or lower than the first threshold voltage Vₜₕ₁ and is higher than the second threshold voltage Vₜₕ₂ set to a value lower than the first threshold voltage Vₜₕ₁. The second threshold voltage Vₜₕ₂ may be set to a low voltage at which the operation of the FC system 4 can be stopped. As a result, in the FC system 4 during the execution of the oxygen consumption control, it is possible to shorten the time required for the oxygen consumption control while suppressing the generated electric power from becoming excessive.

In addition, the management ECU 2 sets the voltage drop rates of the first voltage drop rate and the second voltage drop rate on the basis of at least one of the charge state of the battery 103 and the oxygen concentration of the FC stack 10, and the voltage drop rate is set such that the change amount per unit time becomes smaller as the charge state becomes closer to full charge or as the oxygen concentration becomes higher. As a result, on the basis of the charge state of the battery 103 and/or the oxygen concentration of the FC stack 10, it is possible to shorten the time required for the oxygen consumption control while suppressing the generated electric power during execution of the oxygen consumption control from becoming excessive.

In addition, the management ECU 2 sets the voltage drop rates of the first voltage drop rate and the second voltage drop rate on the basis of the degradation state of the FC stack 10, and the voltage drop rate can be set such that the change rates of the first voltage drop rate and the second voltage drop rate become larger as the degree of degradation of the FC stack 10 is larger. As a result, on the basis of the degradation state of the FC stack 10, it is possible to shorten the time required for the oxygen consumption control while suppressing the generated electric power during execution of the oxygen consumption control from becoming excessive.

In addition, when the oxygen consumption control is started in one FC system 4, the management ECU 2 closes the cathode shutoff valve in the FC system 4, and sets the output voltage of the FC stack 10 in the FC system 4 to the first predetermined value voltage Vₚ that is higher than the first threshold voltage Vₜₕ₁ and lower than the open-circuit voltage. As a result, in the FC stack 10 having a high oxygen concentration at the start of the oxygen consumption control, by setting the FC stack 10 to a high-voltage state under an extremely low load, it is possible to avoid the generation of the open-circuit voltage and suppress degradation of the fuel cell while preventing the generated electric power from exceeding the allowable electric power of the battery.

In addition, after the output voltage of the FC stack 10 in one FC system 4 has become equal to or lower than the second threshold voltage Vₜₕ₂, the management ECU 2 stops the operation of the FC system 4. As a result, since the operations of the FC systems 4 in which the output voltage of the FC stack 10 has become equal to or lower than the second threshold voltage Vₜₕ₂ can be sequentially stopped, it is possible to shorten the overall stop time of the plurality of FC systems 4.

In addition, when the first drop processing in one FC system 4 is completed, the management ECU 2 closes the cathode shutoff valve and starts the oxygen consumption control in the next FC system 4. As described above, when the first drop processing in one FC system 4 is completed, the oxygen consumption control is started in the next FC system 4, and thus a certain amount of time is provided until the first drop processing is started in the next FC system 4. As a result, it is possible to adjust the timing such that the first drop processing is started in the next FC system 4 at a stage where the generated electric power in one FC system 4 has sufficiently decreased. Therefore, even in a case where the number of FC systems 4 performing power generation is large and the total generated electric power tends to increase, it is possible to shorten the time required for the oxygen consumption control while suppressing the overall generated electric power during the oxygen consumption control from becoming excessive. In addition, it is possible to suppress degradation of the FC stack 10 by shortening the time during which the output voltage of the FC stack 10 is maintained at the first predetermined value voltage Vₚ.

### Second Embodiment

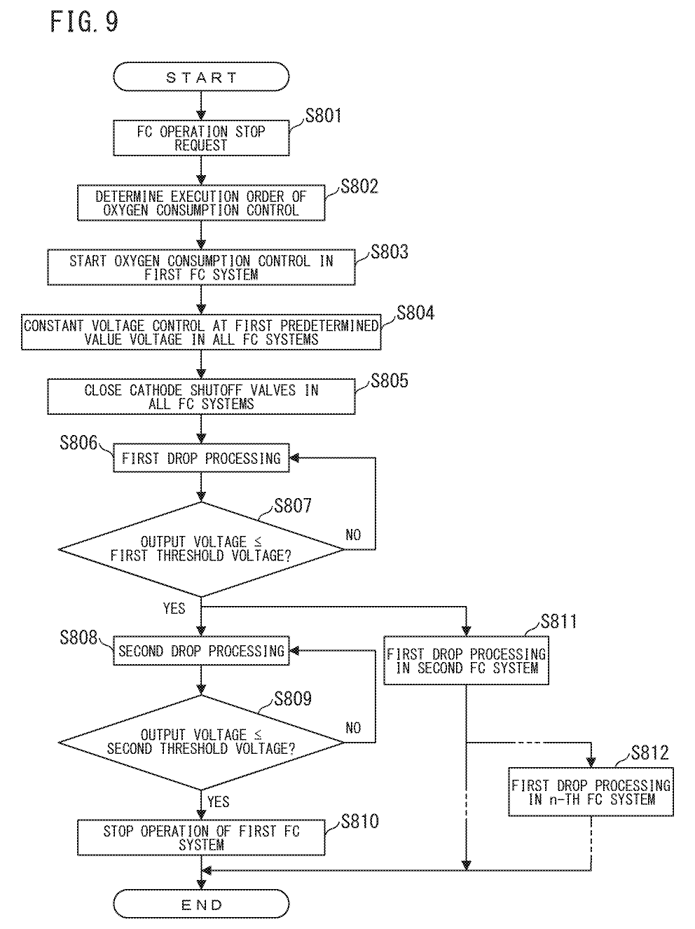

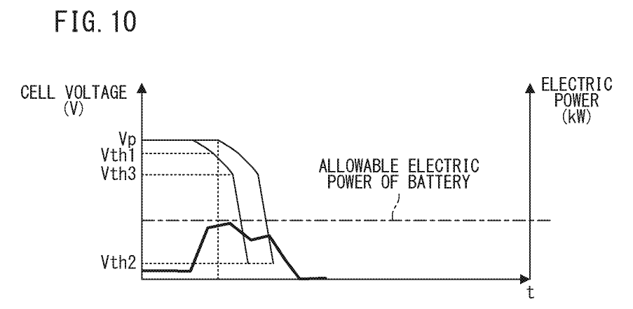

Next, a fuel cell control system according to a second embodiment of the present invention will be described with reference to FIGS. 9 and 10. The configuration of the fuel cell control system of the second embodiment is the same as that of the fuel cell control system 1 of the first embodiment, but differs in the control processing in the operation stop control of the plurality of FC systems 4. Therefore, the description of the configuration of the fuel cell control system of the second embodiment will be omitted, and the differences from the first embodiment in the operation stop control will mainly be described.

FIG. 9 is a flowchart illustrating operation stop control processing in the fuel cell control system according to the second embodiment. In this control processing, the management ECU 2 receiving an operation stop request for the plurality of FC systems 4 from the vehicle control device 101 as step 801, determining an execution order of the oxygen consumption control among the plurality of FC systems 4 as step 802, and starting execution of the oxygen consumption control in the first FC system 4 as step 803 are the same as steps 401, 402, and 403 in the first embodiment, and thus their detailed descriptions will be omitted.

In the subsequent step 804, instead of starting the constant-voltage control only in the first FC system 4 as in step 404, constant-voltage control at the first predetermined value voltage Vₚ is started in all of the FC systems 4. Then, in step 805, the discharge-side shutoff valve 27 serving as the cathode shutoff valve is closed in all of the FC systems 4. As described above, closing of the cathode shutoff valve in step 805 may be performed before the completion or before the start of step 804.

Thereafter, in step 806, the first drop processing is started in the first FC system 4, and in step 807, it is determined whether or not the output voltage of the FC stack 10 in the first FC system 4 has become equal to or lower than the first threshold voltage Vₜₕ₁.

The series of processing of performing the second drop processing in the first FC system 4 (step 808) in a case where the output voltage of the FC stack 10 has become equal to or lower than the first threshold voltage Vₜₕ₁, determining whether or not the output voltage has become equal to or lower than the second threshold voltage Vₜₕ₂ (step 809), and stopping the operation of the first FC system 4 (step 810) in a case where the output voltage has become equal to or lower than the second threshold voltage Vₜₕ₂ is the same as steps 408, 409, and 410 in the first embodiment, detailed description thereof will be omitted.

On the other hand, in a case where the output voltage of the FC stack 10 in the first FC system 4 has become equal to or lower than the first threshold voltage Vₜₕ₁ (step 807: YES), the first drop processing is started in the second FC system 4 in step 811. The difference lies in that, in a case where the output voltage of the FC stack 10 in the first FC system 4 has become equal to or lower than the first threshold voltage Vₜₕ₁, in the first embodiment, as step 411, the oxygen consumption control is started in the second FC system 4, and the constant voltage control at the first predetermined value voltage and the closing of the cathode shutoff valve are performed, but in the second embodiment, the first drop processing is immediately started in the second FC system 4.

Since the subsequent control processing in the second FC system 4 is substantially identical to the processing of steps 807 to 810 in the first FC system 4, illustration thereof is omitted.

Similarly, at the timing when the result of the determination processing corresponding to step 807 in the second FC system 4 is YES and the first drop processing in the second FC system 4 is completed, the first drop processing is immediately started in the third FC system 4. In the same manner, the execution of the first drop processing is started in the n-th FC system 4 (step 812), and by stopping the operation of the n-th FC system 4 through the processing corresponding to step 810, the operation of all the FC systems 4 is stopped, and the present processing is completed.

FIG. 10 illustrates execution timings of the oxygen consumption control in the plurality of FC systems 4 according to the second embodiment. For convenience, only execution timings of the oxygen consumption control in the first FC system 4 and the second FC system 4 are illustrated, but the execution timings in the third and subsequent FC systems 4 are the same.

As illustrated in the drawing, at the timing when the oxygen consumption control is started in the first FC system 4, the oxygen consumption control is also substantially started in the second FC system 4, and in both the first and second FC systems 4, the constant voltage control at the first predetermined value voltage Vₚ is started simultaneously, and the cathode shutoff valve is closed. Thereafter, when the first drop processing in the first FC system 4 is completed, the first drop processing is immediately started in the second FC system 4. Accordingly, although the combined overall generated electric power of the first FC system 4 and the second FC system 4 increases, the second voltage drop rate of the first FC system 4 and the first voltage drop rate of the second FC system 4 are set such that the generated electric power does not exceed the allowable electric power of the battery.

### Effects of Second Embodiment

As described above, in the second embodiment, when the first drop processing in one FC system 4 is completed, the management ECU 2 immediately starts the first drop processing in the next FC system 4. Unlike in the first embodiment, where the oxygen consumption control is started in the second FC system 4 after completion of the first drop processing in the first FC system 4, the execution timings of the oxygen consumption control of the respective FC systems 4 are overlapped such that the first drop processing is immediately started in the second FC system 4 at a stage where the first drop processing in the first FC system 4 is completed. Accordingly, throughout all of the plurality of FC systems 4, it is possible to further shorten the overall time required for the operation stop control while preventing the generated electric power during the oxygen consumption control from becoming excessive.

### Third Embodiment

Next, a fuel cell control system according to a third embodiment of the present invention will be described. The configuration of the fuel cell control system according to the third embodiment is the same as that of the fuel cell control system 1 of the first embodiment and the fuel cell control system of the second embodiment, except that the control processing in the operation stop control is switched according to the number of FC systems 4 performing power generation. Therefore, the description of the configuration of the fuel cell control system according to the third embodiment will be omitted, and the characteristics of the operation stop control will be mainly described.

In a case where a plurality of FC systems 4 are provided in parallel, not all of the FC systems 4 necessarily perform power generation at all times. It is conceivable that, in view of factors such as failure, degradation, or power generation efficiency, only some of the FC systems perform power generation. In the fuel cell control system according to the third embodiment, among the plurality of FC systems 4, when the number of FC systems 4 that are actually performing power generation is smaller than a predetermined number (for example, three systems), the same operation stop control as in the second embodiment described above is executed, and when the number of FC systems 4 that are actually performing power generation is equal to or greater than the predetermined number, the same operation stop control as in the first embodiment described above is executed.

That is, when the number of FC systems 4 performing power generation is small (for example, two systems), at the start of the oxygen consumption control in one FC system 4, in all of the FC systems 4 that are performing power generation, constant voltage control at the first predetermined value voltage Vₚ is started simultaneously, and the cathode shutoff valves are closed. When the first drop processing in one FC system 4 is completed, the first drop processing is immediately started in the next FC system 4.

In addition, when the number of FC systems 4 performing power generation is large (for example, three or more systems), at the start of the oxygen consumption control in one FC system 4, only in the one FC system 4, constant voltage control at the first predetermined value voltage Vₚ is started, and the cathode shutoff valve is closed. In addition, when the first drop processing in the one FC system 4 is completed, in the next FC system 4, the cathode shutoff valve is closed and the oxygen consumption control is started.

### Effects of Third Embodiment

In this manner, in the third embodiment, in a case where the number of FC systems 4 performing power generation is small, the cathode shutoff valves of all of the FC systems 4 performing power generation are closed when the oxygen consumption control is started in one FC system 4, and after the first drop processing in one FC system 4 is completed, the execution of the first drop processing is immediately started in the next FC system 4. As a result, in a case where the number of FC systems 4 performing power generation is small and the total generated electric power tends not to increase, it is possible to shorten the time until the oxygen consumption control is completed in all of the plurality of FC systems 4.

In addition, in a case where the number of FC systems 4 performing power generation is large, when the oxygen consumption control is started in one FC system 4, only the cathode shutoff valve of the one FC system 4 is closed, and after the first drop processing in the one FC system 4 is completed, the cathode shutoff valve of the next FC system 4 is closed, and the oxygen consumption control is started. As a result, in a case where the number of FC systems 4 performing power generation is large and the total generated electric power tends to increase, it is possible to shorten the time during which the FC stack 10 in each FC system 4 is maintained at the first predetermined value voltage Vₚ to suppress deterioration of the FC stack 10, and to shorten the time required for the oxygen consumption control while suppressing the total generated electric power during the oxygen consumption control from becoming excessive.

Note that the present invention is not limited to the described embodiments, and can be implemented in various modes. In addition, the detailed configuration can be changed as appropriate within the scope of the gist of the present invention.

What is claimed is:

1. A fuel cell control system comprising:
a plurality of fuel cell systems in which a plurality of fuel cell systems are provided in parallel, each of the plurality of fuel cell systems including a fuel cell that performs power generation through an electrochemical reaction between fuel gas supplied to an anode and oxidant gas supplied to a cathode;
a cathode shutoff valve that is provided on an upstream side and a downstream side of the cathode of the fuel cell in each of the fuel cell systems, and changes a supply amount of the oxidant gas to the cathode in accordance with an opening degree of the cathode shutoff valve;
a voltage detection unit that detects an output voltage of the fuel cell in each of the fuel cell systems; and
an oxygen consumption control unit that executes oxygen consumption control in which, when stopping operation of the plurality of fuel cell systems, power generation of the fuel cell in each of the fuel cell systems is continued in a state where the cathode shutoff valve is closed, to consume oxygen remaining in the fuel cell,
wherein the oxygen consumption control unit executes, when stopping operation of the plurality of fuel cell systems, in a case where the detected output voltage of the fuel cell in one selected fuel cell system is higher than a first threshold voltage that is higher than an output voltage during normal power generation, first drop processing of decreasing the output voltage of the fuel cell in the one selected fuel cell system at a first voltage drop rate, and executes, in a case where the detected output voltage of the fuel cell has become equal to or lower than the first threshold voltage, second drop processing of decreasing the output voltage of the fuel cell in the one selected fuel cell system at a second voltage drop rate having a larger change amount per unit time than the first voltage drop rate, and
in a case where the first drop processing in the one selected fuel cell system is completed, the oxygen consumption control unit starts execution of the first drop processing in a next one of the fuel cell systems.

2. The fuel cell control system according to claim 1,
wherein the oxygen consumption control unit executes the first drop processing until the detected output voltage of the fuel cell becomes equal to or lower than the first threshold voltage, and
the oxygen consumption control unit executes the second drop processing in a case where the detected output voltage of the fuel cell is equal to or lower than the first threshold voltage and is higher than a second threshold voltage that is set to a value lower than the first threshold voltage.

3. The fuel cell control system according to claim 2, further comprising:
a battery capable of supplying generated electric power of the fuel cell; and
an oxidant gas concentration acquisition unit that acquires an oxidant gas concentration in the fuel cell in each of the fuel cell systems,
wherein the oxygen consumption control unit sets voltage drop rates of the first voltage drop rate and the second voltage drop rate on the basis of at least one of a charge state of the battery and the oxidant gas concentration, and
the voltage drop rate is set such that the change amount per unit time becomes smaller as the charge state becomes closer to full charge or as the oxidant gas concentration becomes higher.

4. The fuel cell control system according to claim 2, further comprising:
a degradation state acquisition unit that acquires a degradation state of the fuel cell in each of the fuel cell systems,
wherein voltage drop rates of the first voltage drop rate and the second voltage drop rate are set such that the change amount per unit time becomes larger as a degradation degree indicated by the degradation state increases.

5. The fuel cell control system according to claim 3,
wherein when starting the oxygen consumption control in the one selected fuel cell system, the oxygen consumption control unit closes the cathode shutoff valve in the one selected fuel cell system, and sets the output voltage of the fuel cell in the one selected fuel cell system to a first predetermined value voltage that is higher than the first threshold voltage and lower than an open-circuit voltage.

6. The fuel cell control system according to claim 5,
wherein the oxygen consumption control unit stops an operation of the one selected fuel cell system after the detected output voltage of the fuel cell becomes equal to or lower than the second threshold voltage.

7. The fuel cell control system according to claim 6,
wherein when the first drop processing in the one selected fuel cell system is completed, the oxygen consumption control unit closes the cathode shutoff valve and starts the oxygen consumption control in the next one of the fuel cell systems.

8. The fuel cell control system according to claim 6,
wherein when the first drop processing in the one selected fuel cell system is completed, the oxygen consumption control unit immediately starts the first drop processing in the next one of the fuel cell systems.

9. The fuel cell control system according to claim 6,
wherein the number of fuel cell systems performing power generation among the plurality of fuel cell systems is smaller than a predetermined number, the cathode shutoff valve of each of all of the fuel cell systems performing power generation is closed at the time of start of the oxygen consumption control in the one selected fuel cell system, and after the first drop processing in the one selected fuel cell system is completed, execution of the first drop processing is immediately started in the next one of the fuel cell systems, and
when the number of fuel cell systems performing power generation among the plurality of fuel cell systems is equal to or greater than the predetermined number, only the cathode shutoff valve of the fuel cell system in which the oxygen consumption control is started is closed, and when the first drop processing in the one selected fuel cell system is completed, the cathode shutoff valve is closed and the oxygen consumption control is started in the next one of the fuel cell systems.
